(19) United States
(12) Patent Application Publication
(10) Pub. No.: US 2021/0270012 A1
(43) Pub. Date: Sep. 2, 2021

(54) WORK MACHINE AND MOTOR GRADER

(71) Applicant: KOMATSU LTD., Minato-ku, Tokyo (JP)

(72) Inventors: Hajime SUMIYA, Minato-ku, Tokyo (JP); Masahiko HAMAGUCHI, Minato-ku, Tokyo (JP); Kohei OTA, Minato-ku, Tokyo (JP); Daisuke HASHIBA, Minato-ku, Tokyo (JP)

(73) Assignee: KOMATSU LTD., Minato-ku, Tokyo (JP)

(21) Appl. No.: 17/254,995

(22) PCT Filed: Feb. 26, 2019
(86) PCT No.: PCT/JP2019/007336

§ 371 Date: Dec. 22, 2020

(30) Foreign Application Priority Data
Jul. 9, 2018 (JP) 2018-130129

(51) Int. Cl. E02F 9/20; E02F 9/22

(52) U.S. Cl. CPC E02F 9/2004; E02F 3/84; E02F 9/225

(57) ABSTRACT

A work implement lever is supported by a left console for operating a work implement. A steering control lever is supported by a left console behind the work implement lever for operating a steering mechanism. The steering control lever includes an upper surface and a stick located below the upper surface. The upper surface is pivotable with a center of pivot of the stick being the center, and the upper surface has an arc shape as viewed from a direction in which the center of pivot extends.

### TECHNICAL FIELD

The present disclosure relates to a work machine and a motor grader.

### BACKGROUND ART

U.S. Pat. No. 7,913,798 (PTL 1) discloses a configuration of a motor grader in which a plurality of joysticks are disposed in a console box. In PTL 1, one of the plurality of joysticks is moved in a fore/aft direction for side-shift control of a blade and is moved laterally for steering control of the motor grader.

### CITATION LIST

### Patent Literature

PTL 1: U.S. Pat. No. 7,913,798

### SUMMARY OF INVENTION

### Technical Problem

When a steering and a work implement are controlled simultaneously using the plurality of joysticks disclosed in PTL 1, it may be difficult to precisely operate a steering and the work implement.

An object of the present disclosure is to provide a work machine and a motor grader that facilitate precise operation of both of a steering and a work implement even when the steering and the work implement are controlled simultaneously.

### Solution to Problem

A work machine of the present disclosure includes a work implement, a steering mechanism, a driver's seat, a console, at least one work implement lever, and a steering control lever. The console is disposed lateral to the driver's seat. The at least one work implementation lever is supported by the console and operating the work implement. The steering control lever is supported by the console behind the at least one work implement lever and operating the steering mechanism. The steering control lever includes an upper surface and a lower portion located below the upper surface. The upper surface is pivotable around a center of pivot in the lower portion, and the upper surface has an arc shape as viewed from a direction in which the center of pivot extends.

A motor grader of the present disclosure is formed of the work machine.

### Advantageous Effects of Invention

According to the present disclosure, a work machine and a motor grader can be provided that facilitate precise operation of both of a steering and a work implement even when the steering and the work implement are controlled simultaneously.

### BRIEF DESCRIPTION OF DRAWINGS

FIG. 1 is a perspective view schematically showing a configuration of a motor grader in an embodiment.

FIG. 2 is a lateral view schematically showing the configuration of the motor grader in an embodiment.

FIG. 3 is a plan view showing a configuration inside a cab of the motor grader in an embodiment.

FIG. 4 is a perspective view showing configurations of control levers disposed in a console.

FIG. 5 is a plan view showing the configurations of the control levers disposed in the console.

FIGS. 6(A) and 6(B) are a lateral view and a rear view showing a configuration of a steering control lever.

FIG. 7 shows how the steering control lever pivots.

FIG. 8 is a lateral view showing configurations of a driver's seat and control levers in a cab.

FIG. 9 is a plan view for explaining a maximum clearance between a work implement lever 35RL and a steering control lever in a first mode of operation of the control lever.

FIG. 10 is a plan view for explaining a maximum clearance between a work implement lever 35RR and the steering control lever in a second mode of operation of the control lever.

FIG. 11 is a hydraulic circuit diagram showing a configuration of a steering mechanism.

### DESCRIPTION OF EMBODIMENTS

A work machine according to an embodiment of the present disclosure will now be described with reference to the drawings. In the following description, the same components will be denoted by the same reference numerals, and may have the same names and the same functions, and thereby, the detailed description thereof will not be repeated.

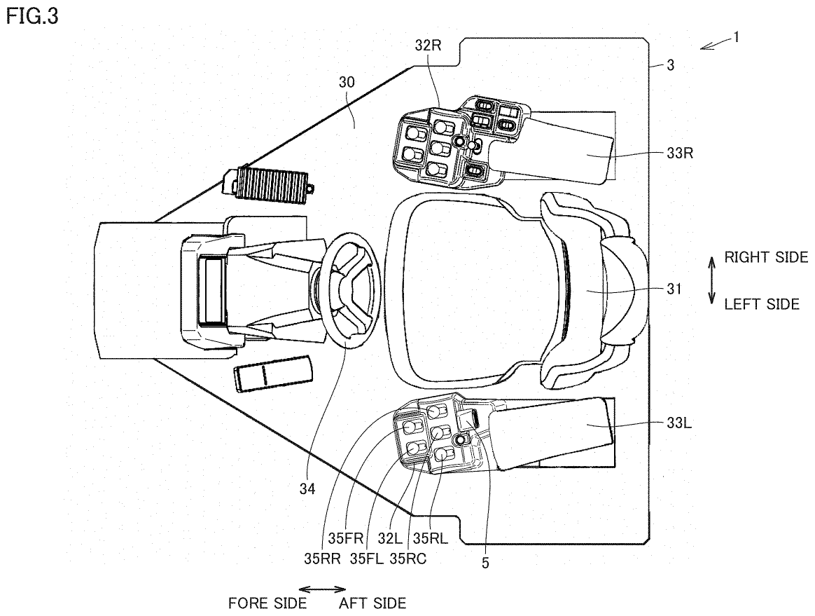

First, a description will be given of the configuration of a motor grader as an example of a work machine to which the concept of the present disclosure is applicable. The present disclosure is also applicable to other work machines, such as hydraulic excavators, crawler dozers, and wheel loaders, in addition to motor graders. In the following, “plan view” means a view as viewed from a direction orthogonal to the upper surface of a floor 30 (FIG. 3) of a cab 3.

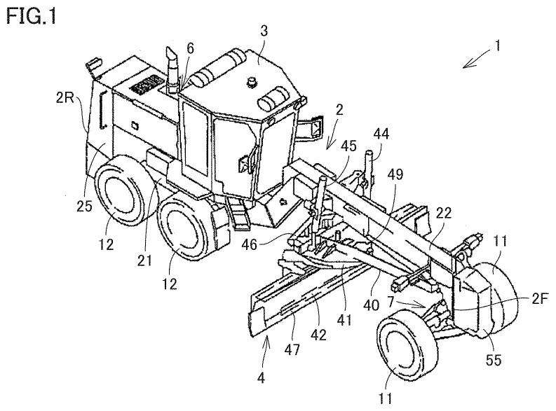

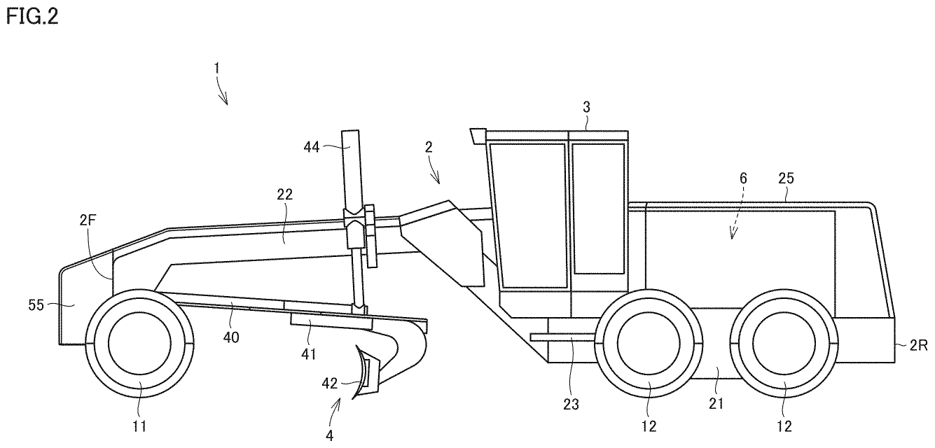

FIGS. 1 and 2 are a perspective view and a lateral view schematically showing the configuration of a motor grader in an embodiment, respectively. As shown in FIGS. 1 and 2, a motor grader 1 in the present embodiment mainly includes running wheels 11, 12, a body frame 2, cab (operator's cab) 3, and a work implement 4. Motor grader 1 also includes components such as an engine arranged in an engine compartment 6. Work implement 4 includes, for example, a blade 42. Motor grader 1 can perform work, such as land-grading work, snow removal work, light cutting, and mixing of materials, with blade 42.

Running wheels 11, 12 include front wheels 11 and rear wheels 12. Although FIGS. 1 and 2 show a total of six running wheels including two front wheels 11 (one on either side) and four rear wheels 12 (two on either side), the number and arrangement of front wheels 11 and rear wheels 12 are not limited to the examples shown in FIGS. 1 and 2.

In the description of the drawings below, a direction in which motor grader 1 travels in straight lines is referred to as a fore/aft direction of motor grader 1. In the fore/aft direction of motor grader 1, a side where front wheels 11 are arranged with respect to work implement 4 is defined as the fore direction. In the fore/aft direction of motor grader 1, a side where rear wheels 12 are arranged with respect to work implement 4 is defined as the aft direction. A lateral direction of motor grader 1 is a direction orthogonal to the fore/aft direction in plan view. A right side and a left side in the lateral direction in facing front are defined as a right direction and a left direction, respectively. An upward/downward direction of motor grader 1 is a direction orthogonal to the plane defined by the fore/aft direction and the lateral direction. In the upward/downward direction, a side where the ground is located is defined as a lower side, and a side where the sky is located is defined as an upper side.

The fore/aft direction refers to a fore/aft direction of the operator sitting on a driver's seat in cab 3. The lateral direction refers to a lateral direction of the operator sitting on the driver's seat. The lateral direction refers to a direction of a vehicle width of motor grader 1. The upward/downward direction refers to an upward/downward direction of the operator sitting on the driver's seat. A direction in which the operator sitting on the driver's seat faces is defined as the fore direction, and a direction behind the operator sitting on the driver's seat is defined as the aft direction. A right side and a left side at the time when the operator sitting on the driver's seat faces front are defined as the right direction and the left direction, respectively. A foot side and a head side of the operator sitting on the driver's seat are defined as a lower side and an upper side, respectively.

Body frame 2 extends in the fore/aft direction (the lateral direction in FIG. 2). Body frame 2 has a front end 2F, which is the forefront portion, and a rear end 2R, which is the rearmost portion. Body frame 2 includes a rear frame 21 and a front frame 22.

Rear frame 21 supports an exterior cover 25 and components such as the engine arranged in engine compartment 6. Exterior cover 25 covers engine compartment 6. For example, each of four rear wheels 12 is attached to rear frame 21. Each of four rear wheels 12 is rotatably driven by driving force from the engine.

Front frame 22 is attached in the front of rear frame 21. Front frame 22 is pivotably coupled to rear frame 21. Front frame 22 extends in the fore/aft direction. Front frame 22 includes a base end portion coupled to rear frame 21 and a tip end portion opposite to the base end portion. The base end portion of front frame 22 is coupled to a tip end portion of rear frame 21 by means of a central pin extending in the upward/downward direction.

An articulation cylinder 23 is attached between front frame 22 and rear frame 21. Front frame 22 is provided as being pivotable with respect to rear frame 21 as a result of extension and retraction of articulation cylinder 23. Articulation cylinder 23 is provided to extend and retract as a result of operation of the control lever provided in cab 3.

For example, two front wheels 11 are rotatably attached to the tip end portion of front frame 22. Front wheel 11 is attached as being revolvable with respect to front frame 22 as a result of extension and retraction of a steering cylinder 7. Motor grader 1 can change a direction of travel as a result of extension and retraction of steering cylinder 7. Steering cylinder 7 can extend and retract as a result of operation of a steering wheel or a steering control lever provided in cab 3.

A counterweight 55 is attached to front end 2F of body frame 2. Counterweight 55 represents one type of attachments to be attached to front frame 22. Counterweight 55 is attached to front frame 22 in order to increase a downward load to be applied to front wheel 11 to allow steering and to increase a pressing load on blade 42.

Cab 3 is carried on front frame 22. In cab 3, an operation portion (not shown), such as a steering wheel, a gear shift lever, a lever for controlling work implement 4, a brake, an accelerator pedal, and an inching pedal, is provided. Cab 3 may be carried on rear frame 21.

Work implement 4 mainly includes, for example, a drawbar 40, a swing circle 41, and a blade 42. Drawbar 40 is disposed below front frame 22. Drawbar 40 has a front end portion coupled to the tip end portion of front frame 22 by means of a ball bearing portion. The front end portion of drawbar 40 is swingably attached to the tip end portion of front frame 22.

Drawbar 40 has a rear end portion supported on front frame 22 by lift cylinders 44, 45. As a result of extension and retraction of lift cylinders 44, 45, the rear end portion of drawbar 40 can move up and down with respect to front frame 22. Drawbar 40 can also swing up and down with an axis extending in the direction of travel of the vehicle being the center, as a result of extension and retraction of lift cylinders 44, 45. Drawbar 40 can also move laterally with respect to front frame 22 as a result of extension and retraction of a drawbar shift cylinder 46.

Swing circle 41 is disposed below front frame 22. Swing circle 41 is disposed below drawbar 40. Swing circle 41 is swingably (rotatably) attached to the rear end portion of drawbar 40. Swing circle 41 can be driven by a hydraulic motor 49 as being swingable clockwise or counterclockwise with respect to drawbar 40 when viewed from above the vehicle. Blade 42 is provided on swing circle 41. As swing circle 41 is driven to swing, a blade angle of blade 42 is adjusted. The blade angle is a tilt angle of blade 42 with respect to the fore/aft direction of motor grader 1.

Blade 42 is disposed between front wheel 11 and rear wheel 12. Front wheel 11 is disposed in front of blade 42. Rear wheel 12 is disposed behind blade 42. Blade 42 is disposed between front end 2F of body frame 2 and rear end 2R of body frame 2. Blade 42 is supported on swing circle 41. Blade 42 is supported on drawbar 40 with swing circle 41 interposed therebetween. Blade 42 is supported on front frame 22 with swing circle 41 and drawbar 40 interposed therebetween.

Blade 42 is movably supported laterally with respect to swing circle 41. Specifically, a blade shift cylinder 47 is attached to swing circle 41 and blade 42 and is arranged longitudinally of blade 42. Blade shift cylinder 47 allows blade 42 to move laterally with respect to swing circle 41. Blade 42 can move in the direction intersecting the longitudinal direction of front frame 22.

Blade 42 is also supported as being swingable with respect to swing circle 41 with the axis extending longitudinally of blade 42 being the center. Specifically, a tilt cylinder (not shown) is attached to swing circle 41 and blade 42. As a result of extraction and retraction of the tilt cylinder, blade 42 can swing with respect to swing circle 41 with the axis extending longitudinally of blade 42 being the center, thereby changing a tilt angle with respect to the direction of travel of blade 42.

As described above, blade 42 is configured to move up and down with respect to the vehicle, swing with the axis extending in the direction of travel of the vehicle being the center, change the tilt angle with respect to the fore/aft direction, move in the lateral direction, and swing with the axis extending longitudinally of blade 42 being the center, with drawbar 40 and swing circle 41 interposed therebetween.

Next, the configuration in the cab in the present embodiment will be described with reference to FIG. 3.

FIG. 3 is a plan view showing a configuration inside a cab of a motor grader in an embodiment. As shown in FIG. 3, motor grader 1 mainly includes a driver's seat 31, a right console 32R, a left console 32L, a control lever, a right armrest 33R, a left armrest 33L, and a steering wheel 34 in cab 3.

Driver's seat 31 is a seat on which an operator operating motor grader 1 sits. Each of right console 32R and left console 32L is disposed lateral to driver's seat 31. Specifically, right console 32R is disposed to the right of driver's seat 31, and left console 32L is disposed to the left of driver's seat 31.

Control levers are supported by the upper portion of each of right console 32R and left console 32L. The control levers supported by the upper portion of left console 32L mainly include at least one work implement lever and a steering control lever 5. The at least one work implement lever supported on left console 32L includes work implement levers 35RR, 35RC, 35RL, 35FR, 35FL.

Each of right armrest 33R and left armrest 33L is disposed lateral to driver's seat 31. Each of right armrest 33R and left armrest 33L is a portion on which the operator sitting on driver's seat 31 places the elbow. Each of right armrest 33R and left armrest 33L is located lateral to both of a seat portion and a backrest portion of driver's seat 31. Right armrest 33R is disposed to the right of driver's seat 31, and left armrest 33L is disposed to the left of driver's seat 31.

Right armrest 33R is disposed on right console 32R to be supported on right console 32R. Left armrest 33L is disposed on left console 32L to be supported on left console 32L.

Steering control lever 5 and at least one work implement lever 35RR, 35RC, 35RL, 35FR, 35FL described above are disposed so as not to overlap left armrest 33L in plan view.

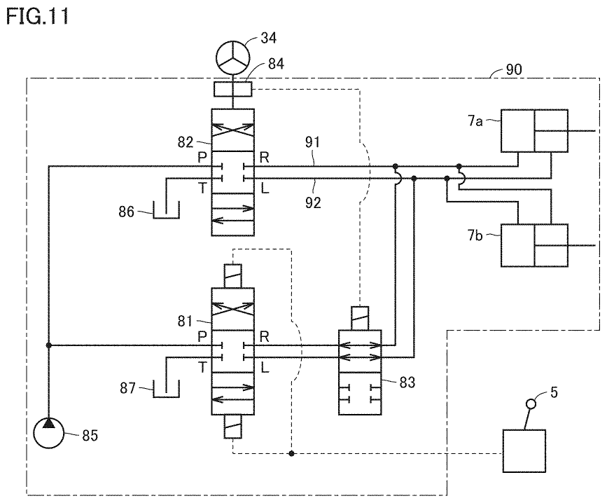

Steering wheel 34 is disposed in front of driver's seat 31. Steering wheel 34 is provided for operating a steering mechanism 90 (FIG. 11), which will be described below. As steering wheel 34 is operated to rotate, steering cylinder 7 shown in FIG. 1 extends and retracts, allowing front wheels 11 to turn with respect to front frame 22. Steering control lever 5 is used only in steering control, for example.

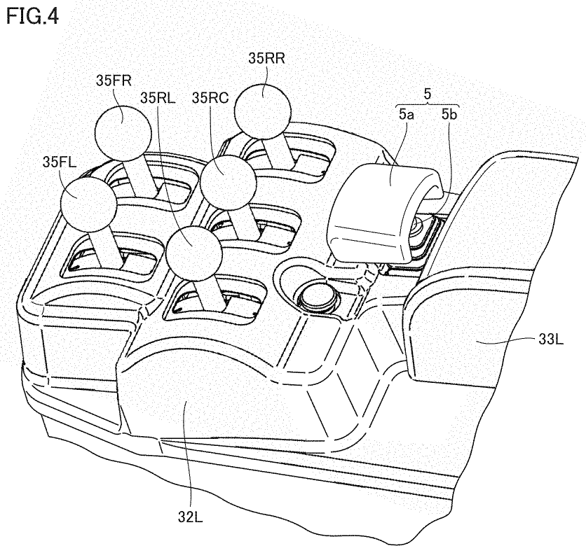

Next, work implement levers 35RR, 35RC, 35RL, 35FR, 35FL and steering control lever 5 will be described with reference to FIGS. 4 to 7.

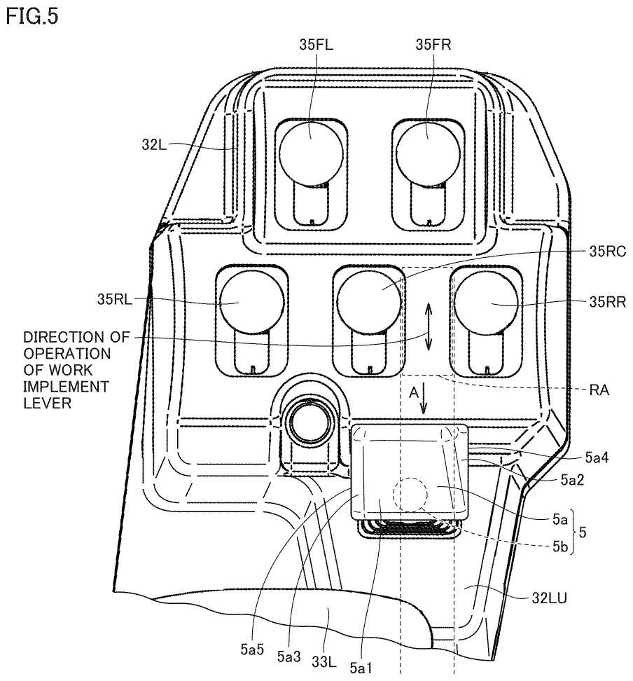

FIGS. 4 and 5 are a perspective view and a plan view showing configurations of control levers disposed in the left console, respectively. As shown in FIG. 4, each of work implement levers 35RR, 35RC, 35RL, 35FR, 35FL is configured to pivot only in the fore/aft direction and not to pivot laterally. Each of work implement levers 35RR, 35RC, 35RL, 35FR, 35FL can be operated as being moved in the fore/aft direction, for example. In the present embodiment, each of work implement levers 35RR, 35RC, 35RL, 35FR, 35FL is operated in the same direction. Each of work implement levers 35RR, 35RC, 35RL, 35FR, 35FL is located at a neutral position while being not operated, and is operated to move forward or rearward from the neutral position.

Work implement lever 35RR is provided for, for example, controlling rotation of swing circle 41. As a result of the operation of work implement lever 35RR, hydraulic motor 49 shown in FIG. 1 is driven, thus allowing swing circle 41 to be driven to swing clockwise or counterclockwise with respect to drawbar 40 as viewed from above the vehicle.

Work implement lever 35RC is provided for, for example, controlling lateral shift of blade 42. As a result of operation of work implement lever 35RC, blade shift cylinder 47 shown in FIG. 1 extends and retracts, thus allowing blade 42 to move laterally with respect to swing circle 41.

Work implement lever 35RL is provided for, for example, controlling the height of the left edge of blade 42. As a result of operation of work implement lever 35RL, lift cylinder 44 shown in FIG. 1 extends and retracts, thus allowing the left edge of blade 42 to move in the upward/downward direction.

Each of work implement levers 35FR, 35FL is provided for, for example, controlling tilt of blade 42 (FIG. 1), up and down movement of a ripper, and articulation of motor grader 1.

Work implement levers 35RR, 35RC, 35RL, 35FR, 35FL and steering control lever 5 described above may be provided in right console 32R, not in left console 32L. In this case, work implement levers 35RR, 35RC, 35RL, 35FR, 35FL and steering control lever 5 may be disposed in right console 32R to be laterally symmetrical to the case in which these levers are provided in left console 32L.

As shown in FIG. 3, the control levers supported by right console 32R include at least one (e.g., five) work implement lever(s). The at least one work implement lever includes two work implement levers disposed side by side laterally on the fore side and three work implement levers disposed side by side laterally on the aft side. Each of these work implement levers is provided for, for example, controlling lateral shift of drawbar 40, tilt (lean) of front wheel 11, the height of the right edge of blade 42, up and down movement of an attachment, or articulation of motor grader 1.

As shown in FIG. 5, work implement lever 35RR (first work implement lever), work implement lever 35RC (second work implement lever), and work implement lever 35RL (third work implement lever) are arranged laterally in line. Work implement lever 35RC is arranged at the center of a plurality of (e.g., three) work implement levers. Work implement lever 35RR is arranged on the rightmost side among the plurality of (e.g., three) work implement levers. Work implement lever 35RL is arranged on the leftmost side among the plurality of (e.g., three) work implement levers. Work implement lever 35RL sandwiches work implement lever 35RC between work implement lever 35RR and work implement lever 35RL.

Each of work implement lever 35FR and work implement lever 35FL is located in front of work implement levers 35RR, 35RC, 35RL. Work implement lever 35FR and work implement lever 35FL are arranged side by side laterally. Work implement lever 35FR is arranged on the right side, and work implement lever 35FL is arranged on the left side.

Work implement lever 35FR is located in front of a region sandwiched between work implement lever 35RR and work implement lever 35RC in the direction in which work implement levers 35RR, 35RC are operated. Work implement lever 35FL is located in front of a region sandwiched between work implement lever 35RC and work implement lever 35RL in the direction in which work implement levers 35RC, 35RL are operated.

As shown in FIG. 4, steering control lever 5 is provided for operating steering mechanism 90 (FIG. 11), which will be described below. Specifically, as steering control lever 5 is operated, steering cylinder 7 shown in FIG. 1 extends and retracts, thus allowing front wheel 11 to turn with respect to front frame 22.

Steering control lever 5 is, for example, a joystick lever. The direction in which steering control lever 5 is operated is a direction intersecting (e.g., a direction orthogonal to) the direction in which each of work implement levers 35RR, 35RC, 35RL, 35FR, 35FL is operated. Steering control lever 5 is configured to, for example, pivot only laterally and not to pivot in the fore/aft direction. Steering control lever 5 can be operated as being moved laterally, for example.

As shown in FIG. 5, steering control lever 5 is disposed behind at least one work implement lever (work implement levers 35RR, 35RC, 35RL, 35FR, 35FL) supported by left console 32L.

Steering control lever 5 is disposed, in plan view, behind a region RA sandwiched between work implement lever 35RR (first work implement lever) and work implement lever 35RC (second work implement lever) in the direction in which work implement levers 35RR, 35RC, 35RL are operated (on the side indicated by the arrow A in the figure). Stick 5b connected to the lower surface of a lever body 5a of steering control lever 5 is also disposed, in plan view, behind region RA in the direction in which work implement levers 35RR, 35RC, 35RL are operated (on the side indicated by the arrow A in the figure).

The direction in which work implement levers 35RR, 35RC, 35RL are located side by side may be inclined, in plan view, with respect to the lateral direction from a point of view of the operator sitting on driver's seat 31. In this case, the direction in which work implement levers 35RR, 35RC, 35RL are located side by side may be inclined with respect to the lateral direction from the operator's point of view such that work implement lever 35RR close to driver's seat 31 is located in front of work implement lever 35RC and work implement lever 35RL far from driver's seat 31 is located behind work implement lever 35RC.

The direction in which work implement levers 35RR, 35RC, 35RL are operated may be inclined, in plan view, with respect to the fore/aft direction from the point of view of the operator sitting on driver's seat 31. In this case, the direction in which work implement levers 35RR, 35RC, 35RL are operated may be inclined with respect to the fore/aft direction from the operator's point of view such that each work implement lever is laterally more distant from driver's seat 31 as each work implement lever moves forward in the direction of operation.

The direction in which steering control lever 5 is operated may be inclined, in plan view, with respect to the lateral direction from a point of view of the operator sitting on driver's seat 31. In this case, the direction in which steering control lever 5 is operated may be inclined with respect to the lateral direction from the operator's point of view such that steering control lever 5 moves rearward as steering control lever 5 is laterally more distant from driver's seat 31.

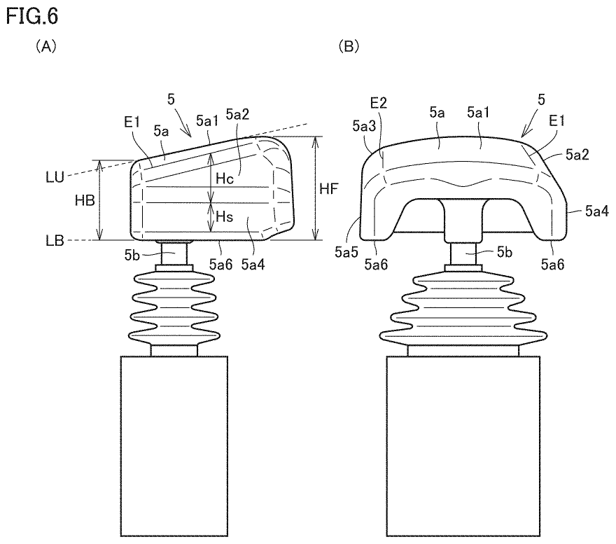

FIGS. 6(A) and 6(B) are a lateral view and a rear view showing a configuration of a steering control lever. As shown in FIGS. 6(A) and 6(B), steering control lever 5 includes an upper surface 5a1 and a lower portion (e.g., stick 5b) located below upper surface 5a1. Steering control lever 5 includes lever body 5a and stick 5b. Lever body 5a includes upper surface 5a1, chamfers 5a2, 5a3, lateral surfaces 5a4, 5a5, and a lower surface 5a6.

As shown in FIG. 6(B), upper surface Sal has a first edge E1 and a second edge E2, which are opposite to each other laterally. Chamfer 5a2 is connected to first edge E1 of upper surface Sal, and chamfer 5a2 is continuous with upper surface Sal. Lateral surface 5a4 is connected to chamfer 5a2 to sandwich chamfer 5a2 between upper surface Sal and lateral surface 5a4, and lateral surface 5a4 is continuous with chamfer 5a2. Lateral surface 5a4 extends, for example, in the upward/downward direction and in the fore/aft direction.

Chamfer 5a2 is inclined to be located on the lower side as chamfer 5a2 extends from first edge E1 of upper surface Sal to the side opposite to second edge E2 to reach an upper edge of lateral surface 5a4. Chamfer 5a2 is inclined while, for example, being rounded from first edge E1 of upper surface Sal to the upper edge of lateral surface 5a4. Note that chamfer 5a2 may be inclined linearly from first edge E1 of upper surface Sal to the upper edge of lateral surface 5a4.

Chamfer 5a3 is connected to second edge E2 of upper surface Sal, and chamfer 5a3 is continuous with upper surface Sal. Lateral surface 5a5 is connected to chamfer 5a3 to sandwich chamfer 5a3 between upper surface Sal and lateral surface 5a5, and lateral surface 5a5 is continuous with chamfer 5a3. Lateral surface 5a5 extends in, for example, in the upward/downward direction and in the fore/aft direction.

Chamfer 5a3 reaches the upper edge of lateral surface 5a5 by inclining so as to be located downward from second edge E2 of upper surface Sal toward the side opposite to first edge E1. Chamfer 5a3 is inclined while, for example, being rounded from second edge E2 of upper surface Sal to the upper edge of lateral surface 5a5. Note that chamfer 5a3 may be inclined linearly from second edge E2 of upper surface Sal to the upper edge of lateral surface 5a5.

As shown in FIG. 6(A), a height He of chamfer 5a2 in lateral view increases from the aft side to the fore side. Height He of chamfer 5a2 is a dimension of projection in the direction in which stick 5b extends from the upper edge of lateral surface 5a4 to first edge E1 of upper surface 5a1 (or a direction orthogonal to lower surface 5a6 of lever body 5a) in lateral view.

A height Hs of lateral surface 5a4 in lateral view is constant from the aft side to some midpoint between the aft side to the fore side and decreases from some midpoint toward the fore side.

The upper end (a portion extending along the broken line LU) of lever body 5a in lateral view is inclined upward toward the fore side with respect to the lower edge (a portion extending along the broken line LB) of lever body 5a in lateral view. As a result, a height HF from the lower end to the upper end of lever body 5a at the front end of lever body 5a is larger than a height HB from the lower end to the upper end of lever body 5a at the rear end of lever body 5a. Each of heights HF, HB is a height in the direction in which stick 5b extends in lateral view (or a direction orthogonal to lower surface 5a6 of lever body 5a).

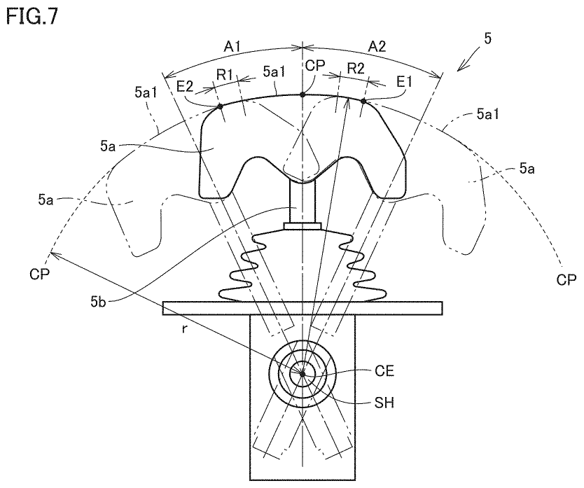

FIG. 7 shows how the steering control lever pivots. As shown in FIG. 7, steering control lever 5 includes upper surface Sal and the lower portion located below upper surface Sal. Upper surface Sal of steering control lever 5 is the upper surface of lever body 5a, and the lower portion of steering control lever 5 is stick 5b.

Upper surface Sal is pivotable with center of pivot CE in the lower portion of steering control lever 5 being the center. Specifically, stick 5b is pivotably supported by a pivot shaft SH such that the upper end of stick 5b swings laterally. Pivot shaft SH pivotably supports stick 5b in the vicinity of the lower end (in the vicinity of the base) of stick 5b. Center of pivot CE of pivot shaft SH extends in, for example, the fore/aft direction. The upper end of stick 5b can swing laterally, for example. Note that the direction in which center of pivot CE extends may be deviated from the fore/aft direction as long as center of pivot CE is located in the plane including the fore/aft direction and the lateral direction.

Steering control lever 5 is located at the neutral position (a position indicated by the solid line in FIG. 7) while being not operated. Steering control lever 5 is operated to move to the right side or the left side through the pivot described above from the neutral position. As stick 5b pivots, steering control lever 5 can move in the direction of operation.

Upper surface Sal of lever body 5a has an arc shape as viewed from the direction in which center of pivot CE extends. The arc shape of upper surface Sal is, for example, a shape extending along the circumference (broken line CP) with center of pivot CE being the center. Specifically, the arc shape of upper surface Sal is located entirely in the circumferential direction at a position with the same distance r from center of pivot CE. Distance r from center of pivot CE of the arc shape of upper surface Sal to a central portion CP of the arc shape as viewed from the direction in which center of pivot CE extends is equal to each of distance r from center of pivot CE to first edge E1 of the arc shape and distance r from center of pivot CE to second edge E2 of the arc shape.

Note that the arc shape of upper surface Sal as viewed from the direction in which center of pivot CE extends may have a radius of curvature different from distance r. Specifically, the arc shape of upper surface Sal as viewed from the direction in which center of pivot CE extends may have a radius of curvature different from distance (radius) r from center of pivot CE to central portion CP of the arc shape. For example, the arc shape of upper surface Sal may have a radius of curvature larger than distance (radius) r from center of pivot CE to central portion CP of the arc shape or have a radius of curvature smaller than distance (radius) r.

In this case, distance r from center of pivot CE of the arc shape of upper surface Sal to central portion CP of the arc shape may be larger or smaller than each of the distance from center of pivot CE to first edge E1 of the arc shape and the distance from center of pivot CE to second edge E2 of the arc shape.

Each of a pivotable angle A1 to one side in the lateral direction and a pivotable angle A2 to the other side in the lateral direction from the neutral position of steering control lever 5 is, for example, 25±1°. A part of upper surface 5a1 with steering control lever 5 pivoted to its maximum extent to one side in the lateral direction from the neutral position (pivoted 25±1° from the neutral position) overlaps a part of upper surface 5a1 located at the neutral position in a region R1. Also, a part of upper surface 5a1 with steering control lever 5 pivoted to its maximum extent to the other side in the lateral direction from the neutral position (pivoted 25±1° from the neutral position) overlaps a part of upper surface Sal located at the neutral position in a region R2.

In the entire upper surface Sal in, for example, the fore/aft direction which is shown in FIG. 6(A), upper surface Sal has a shape extending along the circumference (broken line CP) with center of pivot CE being the center, as shown in FIG. 7.

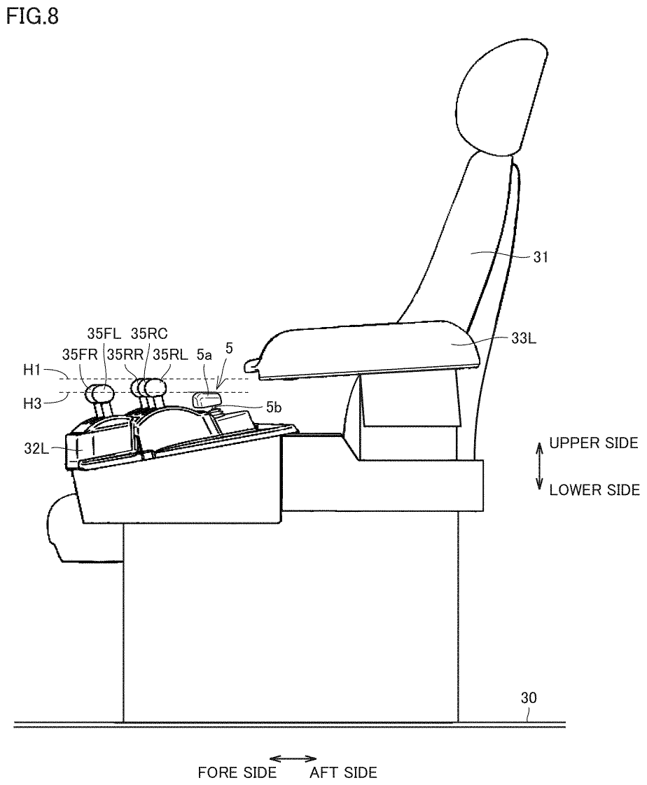

FIG. 8 is a lateral view showing configurations of a driver's seat and control levers in a cab. As shown in FIG. 8, a height position H1 of the upper end of at least one work implement lever 35RR, 35RC, 35RL is above a height position H3 of the upper end of steering control lever 5. Height position H1 of the upper end of each of the upper ends of work implement levers 35RR, 35RC, 35RL is above height position H3 of the upper end of steering control lever 5.

Height position H1 of the upper end of work implement lever 35RR, height position H1 of work implement lever 35RC, and height position H1 of the upper end of work implement lever 35RL are nearly the same.

Height positions H1, H3 described above refer to the heights from the upper surface (floor surface) of floor 30 of cab 3.

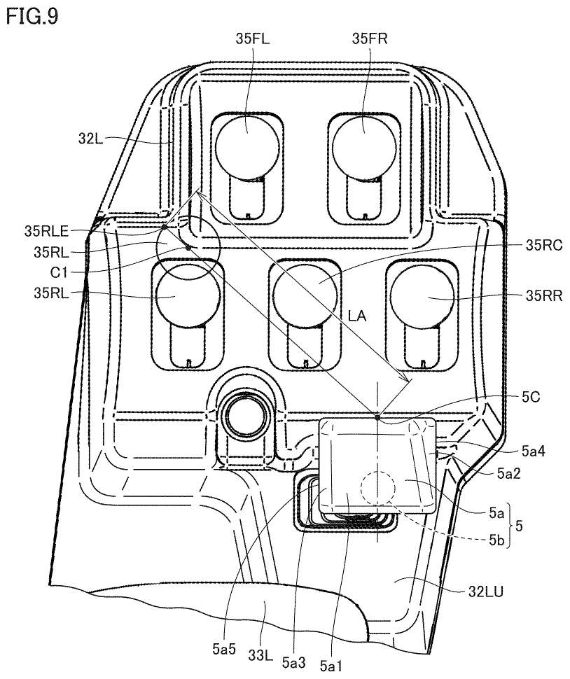

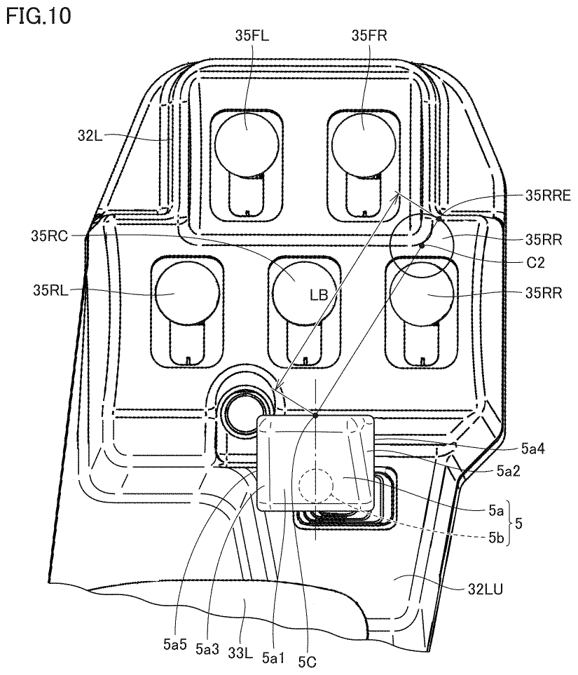

Next, a maximum clearance between steering control lever 5 and the work implement lever in the present embodiment will be described with reference to FIGS. 9 and 10.

FIG. 9 is a plan view for explaining a maximum clearance between work implement lever 35RL and steering control lever 5 in a first mode of operation of the control lever. FIG. 10 is a plan view for explaining a maximum clearance between work implement lever 35RR and steering control lever 5 in a second mode of operation of the control lever.

As shown in FIG. 9, the operator may perform a so-called combined control of operating the work implement while performing steering control. For example, when the operator controls the left end portion of blade 42 to move up and down while performing steering control, the operator operates work implement lever 35RL while operating steering control lever 5.

When steering control lever 5 is pivoted to its maximum extent to the right and work implement lever 35RL is pivoted to its maximum extent to the front through this operation, the distance between steering control lever 5 and work implement lever 35RL is the largest.

If a distance (maximum clearance) LA, which is the largest distance between steering control lever 5 and work implement lever 35RL, is excessively large, the fingers of the left hand of the operator do not reach work implement lever 35RL with the palm of the left hand placed on steering control lever 5. In some situations, accordingly, the operator may fail to perform the above combined control unless maximum clearance LA between steering control lever 5 and work implement lever 35RL is set appropriately.

Thus, maximum clearance LA between steering control lever 5 and work implement lever 35RL is set to, for example, not less than 120 mm and not greater than 160 mm, as shown in FIG. 9. As a result of the above setting of maximum clearance LA, even an operator with relatively short fingers can appropriately perform the above combined control.

Maximum clearance LA in the present disclosure is a distance between a central portion 5C in the lateral direction at the front end of lever body 5a and a front portion 35RLE of work implement lever 35RL with steering control lever 5 pivoted to its maximum extent to the right and work implement lever 35RL pivoted to its maximum extent to the front. Front portion 35RLE of work implement lever 35RL is the foremost point among points at which a virtual straight line passing through central portion 5C and a center C1 of work implement lever 35RL intersects work implement lever 35RL.

As shown in FIG. 10, also, when the operator controls swing circle 41 to rotate while performing steering control as in the above case, the operator operates work implement lever 35RR while operating steering control lever 5.

When steering control lever 5 is pivoted to its maximum extent to the left and work implement lever 35RR is pivoted to its maximum extent to the front through this operation, the distance between steering control lever 5 and work implement lever 35RR is the largest.

If a distance (maximum clearance) LB, which is the largest distance between steering control lever 5 and work implement lever 35RR, is excessively large, the fingers of the left hand do not reach work implement lever 35RR with the palm of the left hand placed on steering control lever 5. In some situations, accordingly, the operator may fail to perform the above combined control unless maximum clearance LB between steering control lever 5 and work implement lever 35RR is set appropriately.

Thus, maximum clearance LB between steering control lever 5 and work implement lever 35RR is set to, for example, not less than 100 mm and not greater than 140 mm, as shown in FIG. 10. As a result of the above setting of maximum clearance LB, even an operator with relatively short fingers can appropriately perform the above combined control.

Maximum clearance LB in the present disclosure is a distance between central portion 5C in the lateral direction at the front end of lever body 5a and front portion 35RRE of work implement lever 35RR with steering control lever 5 pivoted to its maximum extent to the left and work implement lever 35RR pivoted to is maximum extent to the front. Front portion 35RRE of work implement lever 35RR is the foremost point among points at which a virtual straight line passing through central portion 5C and a center C2 of work implement lever 35RR intersects work implement lever 35RR. Maximum clearance LA is preferably larger than maximum clearance LB.

Next, the configuration of the steering mechanism and steering control in the present embodiment will be described with reference to FIG. 11.

FIG. 11 is a hydraulic circuit diagram showing a configuration of a steering mechanism. As shown in FIG. 11, steering mechanism 90 mainly includes a lever valve 81, a steering control valve 82, a steering priority valve 83, a steering angle sensor 84, a pump 85, and oil tanks 86, 87.

Steering wheel 34 is connected to steering control valve 82 with steering angle sensor 84 interposed therebetween. Steering control valve 82 has a port P connected to pump 85. Steering control valve 82 has a port T connected to oil tank 86. Steering control valve 82 has a port R connected to steering cylinders 7a, 7b with oil passage 91 interposed therebetween. Steering control valve 82 has a port L connected to steering cylinders 7a, 7b with oil passage 92 interposed therebetween.

Steering control lever 5 is electrically connected to lever valve 81. This allows for supply of a control signal of steering control lever 5 to lever valve 81. Lever valve 81 has a port P connected to pump 85. Lever valve 81 has a port T connected to oil tank 87. Lever valve 81 has a port R connected to oil passage 91 with steering priority valve 83 interposed therebetween and connected to steering cylinders 7a, 7b with oil passage 91 interposed therebetween. Lever valve 81 has a port L connected to oil passage 92 with steering priority valve 83 interposed therebetween and connected to steering cylinders 7a, 7b with oil passage 92 interposed therebetween. A signal output from steering angle sensor 84 can be supplied to steering priority valve 83.

Steering control in the above steering mechanism is performed as follows.

Oil discharged from pump 85 enters steering control valve 82. When steering wheel 34 is rotated to the right, oil of an amount proportional to the amount of rotation of steering wheel 34 is discharged from port R of steering control valve 82 to each of steering cylinders 7a, 7b. Consequently, the wheels are steered to cause the vehicle to turn right when steering wheel 34 is rotated to the right.

When steering wheel 34 is rotated to the left, oil of an amount proportional to the amount of rotation of steering wheel 34 is discharged from port L of steering control valve 82 to each of steering cylinders 7a, 7b. Consequently, the wheels are steered to cause the vehicle to turn left when steering wheel 34 is rotated to the left.

Oil discharged from pump 85 enters lever valve 81. When steering control lever 5 is pivoted to the right, oil of an amount proportional to the amount of pivot of steering control lever 5 is discharged from port R of lever valve 81 through steering priority valve 83 to each of steering cylinders 7a, 7b. Consequently, the wheels are steered to cause the vehicle to turn right when steering control lever 5 is pivoted to the right.

When steering control lever 5 is pivoted to the left, oil of an amount proportional to the amount of pivot of steering control lever 5 is discharged from port L of lever valve 81 through steering priority valve 83 to each of steering cylinders 7a, 7b. Consequently, the wheels are steered to cause the vehicle to turn left when steering control lever 5 is pivoted to the left.

When steering wheel 34 is operated, a signal output from steering angle sensor 84 is supplied to steering priority valve 83. When steering priority valve 83 receives the signal from steering angle sensor 84, steering priority valve 83 is closed. In both of the case where steering control lever 5 is operated with steering wheel 34 being operated and the case where steering wheel 34 is operated with steering control lever 5 being operated, thus, the operation of steering wheel 34 has priority over the operation of steering control lever 5.

Next, the function and effect of the present embodiment will be described.

According to the present embodiment, upper surface Sal of steering control lever 5 has an arc shape as upper surface Sal is viewed from the direction in which center of pivot CE extends, as shown in FIG. 7. This allows the operator to operate steering control lever 5 with the palm placed on upper surface Sal in a natural state when operating steering control lever 5 with the palm placed on upper surface Sal. The operator thus becomes less distracted by the operation of steering control lever 5, and correspondingly, can concentrate on the operation of each of work implement levers 35RR, 35RC, 35RL, 35FR, 35FL. This facilitates precise operation of both of the steering and work implement 4 even when the steering and the work implement are controlled simultaneously.

According to the present embodiment, the arc shape of upper surface 5a1 is a shape extending along the circumference with center of pivot CE in stick 5b being the center, as shown in FIG. 7. As a result, upper surface 5a1 is continuously located on the circumference even when upper surface Sal is pivoted, thus allowing the operator to become less distracted by the operation of steering control lever 5. This further facilitates precise operation of both of the steering and work implement 4.

According to the present embodiment, in lateral view, the upper end of lever body 5a is inclined upward to the fore side with respect toward the front with respect to the lower end of lever body 5a, as shown in FIG. 6(A). As a result, the fingers are easily inclined upward from the bases toward the tips of the fingers with the palm placed on upper surface Sal. This facilitates the operation of the work implement lever with the fingers even when height position H1 of the upper end of the work implement lever is above height position H3 of the upper end of steering control lever 5, as shown in FIG. 8.

According to the present embodiment, steering control lever 5 has a rectangular shape in plan view, as shown in FIG. 5. This facilitates adjustment of the shape of lever body 5a to the shape of the palm of the operator.

According to the present embodiment, height Hc of chamfer 5a2 located on the driver's seat 31 side increases from the aft side to the fore side in lateral view, as shown in FIG. 6(A). Consequently, the operator can easily place the base of the thumb along chamfer 5a2 with the palm placed on upper surface Sal, to thereby operate steering control lever 5 in a more natural state.

According to the present embodiment, the work implement lever is pivotable in the fore/aft direction, and steering control lever 5 is pivotable laterally, as shown in FIGS. 9 and 10. Steering control lever 5 having upper surface Sal of arc shape as described above is particularly suitable in the combination of the levers pivoted as described above.

According to the present embodiment, height position H1 of each of the upper ends of work implement levers 35RR, 35RC, 35RL is above height position H3 of the upper end of steering control lever 5, as shown in FIG. 8. This reduces or prevents an inadvertent operation of steering control lever 5 when the operator operates the work implement lever with the elbow placed on armrest 33L.

According to the present embodiment, maximum clearance LA between work implement lever 35RL and steering control lever 5 shown in FIG. 9 is larger than maximum clearance LB between work implement lever 35RR and steering control lever 5 shown in FIG. 10. This facilitates the operation when the operator operates the levers with one hand (e.g., left hand).

Maximum clearance LA shown in FIG. 9 is not less than 120 mm and not greater than 160 mm, and maximum clearance LB shown in FIG. 10 is not less than 100 mm and not greater than 140 mm. This allows even an operator with relatively short fingers to easily operate work implement levers 35RL, 35RR while operating steering control lever 5, as described above.

It should be understood that the embodiments disclosed herein are illustrative and not restrictive in all respects. It is intended that the scope of the present invention is not limited to the description above but defined by the scope of the claims and encompasses all modifications equivalent in meaning and scope to the claims.

### REFERENCE SIGNS LIST

1 motor grader; 2 body frame; 2F front end; 2R rear end; 3 cab; 4 work implement; 5 steering control lever; 5C central portion; 5a lever body; Sal upper surface; 5a2, 5a3 chamfer; 5a4, 5a5 lateral surface; 5a6 lower surface; 5b stick; 6 engine compartment; 7, 7a, 7b steering cylinder; 11 front wheel; 12 rear wheel; 21 rear frame; 22 front frame; 23 articulation cylinder; 25 exterior cover; 30 floor; 31 driver's seat; 32L left console; 32R right console; 33L left armrest; 33R right armrest; 34 steering wheel; 35FL, 35FR, 35RC, 35RL, 35RR work implement lever; 35RLE, 35RRE front portion; 40 drawbar; 41 swing circle; 42 blade; 44 lift cylinder; 46 drawbar shift cylinder; 47 blade shift cylinder; 49 hydraulic motor; 55 counterweight; 81 lever valve; 82 steering control valve; 83 steering priority valve; 84 steering angle sensor; 85 pump; 86, 87 oil tank; 90 steering mechanism; 91, 92 oil passage; A1, A2 pivotable angle; C1, C2 center; CE center of pivot; CP central portion; E1 first edge; E2 second edge; LA, LB maximum clearance, R1, R2, RA region; SH pivot shaft.

1. A work machine comprising:
a work implement;
a steering mechanism;
a driver's seat;
a console disposed lateral to the driver's seat;
at least one work implement lever supported by the console and operating the work implement; and
a steering control lever supported by the console behind the at least one work implement lever and operating the steering mechanism, wherein
the steering control lever includes an upper surface, and a lower portion located below the upper surface, and
the upper surface is pivotable around a center of pivot in the lower portion, and the upper surface has an arc shape as viewed from a direction in which the center of pivot extends.

2. The work machine according to claim 1, wherein the arc shape of the upper surface is a shape extending along a circumference centered on the center of pivot in the lower portion.

3. The work machine according to claim 1, wherein
the steering control lever includes a lever body with the upper surface, and
in lateral view, an upper end of the lever body is inclined upward toward a fore side with respect to a lower end of the lever body.

4. The work machine according to claim 1, wherein the steering control lever has a rectangular shape in plan view.

5. The work machine according to claim 1, wherein
the steering control lever includes a lateral surface located on a driver's seat side of the upper surface, and a chamfer located between the upper surface and the lateral surface, and
the chamfer has a height increasing from an aft side to a fore side in lateral view.

6. The work machine according to claim 1, wherein the at least one work implement lever is pivotable in a fore/aft direction, and the steering control lever is pivotable laterally.

7. The work machine according to claim 1, wherein
the at least one work implement lever includes a first work implement lever, a second work implement lever, and a third work implement lever sandwiching the second work implement lever between the first work implement lever and the third work implement lever, and
a maximum clearance between the third work implement lever and the steering control lever is larger than a maximum clearance between the first work implement lever and the steering control lever.

8. A motor grader formed of a work machine according to claim 1.
